(19) United States
(12) Patent Application Publication
(10) Pub. No.: US 2009/0222128 A1
(43) Pub. Date: Sep. 3, 2009

(54) METHODS AND APPARATUS FOR OPERATING AN ELECTRONIC DEVICE MANUFACTURING SYSTEM

(75) Inventors: Daniel O. Clark, Pleasanton, CA (US); Phil Chandler, San Francisco, CA (US); Shaun W. Crawford, San Ramon, CA (US); Jay J. Jung, Sunnyvale, CA (US); Youssef A. Loldj, Sunnyvale, CA (US); Maxime Cayer, Chandler, AZ (US)

Correspondence Address: DUGAN & DUGAN, PC, 245 Saw Mill River Road, Suite 309, Hawthorne, NY, 10532, US

(73) Assignee: Applied Materials, Inc., Santa Clara, CA (US)

(21) Appl. No.: 12/365,894

(22) Filed: Feb. 4, 2009

Related U.S. Application Data
(60) Provisional application No. 61/026,131, filed on Feb. 5, 2008.
(60) Provisional application No. 61/026,432, filed on Feb. 5, 2008.

(51) Int. Cl. G05B 19/18

(52) U.S. Cl. 700/159

(57) ABSTRACT

Methods and apparatus for efficiently operating an electronic device manufacturing system are provided. In one aspect, an electronic device manufacturing system is provided, including: a process tool; a process tool controller linked to the process tool, wherein the process tool controller is adapted to control the process tool; a first sub-fab auxiliary system linked to the process tool controller; wherein the first sub-fab auxiliary system is adapted to operate in a first operating mode and a second operating mode; and wherein the process tool controller is adapted to cause the first sub-fab auxiliary system to change from the first operating mode to the second operating mode.

### CROSS-REFERENCE TO RELATED APPLICATIONS

The present application claims priority to U.S. Provisional Patent Application Ser. No. 61/026,131 filed Feb. 5, 2008 and entitled “Abatement Systems” (Attorney Docket No. 13208/L) and claims priority to U.S. Provisional Patent Application Ser. No. 61/026,432 filed Feb. 5, 2008 and entitled “Abatement Systems” (Attorney Docket No. 13208/L2) all of which are hereby incorporated herein by reference in their entirety for all purposes.

### FIELD OF THE INVENTION

The present invention is related to the manufacture of electronic devices, and is more specifically related to systems and methods for increasing the efficiency of electronic device manufacturing systems.

### BACKGROUND OF THE INVENTION

Electronic device manufacturing facilities, or “fabs”, typically employ process tools which perform manufacturing processes in the production of electronic devices. Such processes may include physical vapor deposition, chemical vapor deposition, etch, cleaning and other electronic device manufacturing processes. It should be understood that the present invention is not limited to any particular electronic device manufacturing process. A fab is typically laid out with a clean room on one floor, and a room containing auxiliary systems and devices which support the clean room on a lower floor, herein referred to as a “sub-fab.” For ease of reference, the phrases ‘auxiliary systems’ and ‘auxiliary devices’ may be used interchangeably herein to describe a sub-fab system and/or device. One important function of the sub-fab is to abate toxic, flammable or otherwise potentially harmful substances which are common byproducts of electronic device manufacturing processes. The sub-fab may contain such auxiliary devices as abatement tools, AC power distributors, primary vacuum pumps, spare vacuum pumps, water pumps, chillers, heat exchangers, process cooling water supplies and delivery systems, electrical power supplies and delivery systems, inert gas dumps, valves, device controllers, clean dry air supplies and delivery systems, ambient air supplies and delivery systems, inert gas supplies and delivery systems, fuel supplies and delivery systems, touch screens, process logic controllers, reagent supplies and delivery systems, etc.

Sub-fabs commonly utilize large amounts of energy and create large amounts of waste heat, which may have a detrimental environmental effect and which may be very expensive for a fab operator. It is therefore desirable to design a sub-fab which uses less energy, creates less waste heat, and is less expensive to operate, without negatively impacting a fab's production.

### SUMMARY OF THE INVENTION

In some aspects, the present invention provides an electronic device manufacturing system which includes a process tool; a process tool controller linked to the process tool, wherein the process tool controller is adapted to control the process tool; a first sub-fab auxiliary system linked to the process tool controller; wherein the first sub-fab auxiliary system is adapted to operate in a first operating mode and a second operating mode; and wherein the process tool controller is adapted to cause the first sub-fab auxiliary system to change from the first operating mode to the second operating mode.

In some aspects an electronic device manufacturing system is provided, including: a process tool; a process tool controller linked to the process tool, wherein the process tool controller is adapted to control the process tool; a sub-fab front end controller linked to the process tool controller; and a first sub-fab auxiliary system linked to the sub-fab front end controller, wherein the first sub-fab auxiliary system is adapted to operate in a first operating mode and a second operating mode; wherein the sub-fab front end controller is adapted to receive a signal from the process tool controller; and wherein the sub-fab front end controller is adapted to cause the first sub-fab auxiliary system to change from the first operating mode to the second operating mode.

In some aspects, a method for operating an electronic device manufacturing system is provided, including: controlling a process tool with a process tool controller; operating a sub-fab auxiliary system in a first mode; and operating the sub-fab auxiliary system in a second mode in response to receipt by the sub-fab auxiliary system of a command from the process tool controller.

In some aspects, a method for operating an electronic device manufacturing system is provided, including: controlling a process tool with a process tool controller; controlling a first sub-fab auxiliary system with a sub-fab auxiliary system controller; operating the first sub-fab auxiliary system in a first mode; sending a first signal from the process tool controller to the sub-fab auxiliary system controller; and in response to the first signal, operating the first sub-fab auxiliary system in a second mode.

In some aspects, a method for operating an electronic device manufacturing system is provided, including: controlling a process tool with a process tool controller; operating a first sub-fab auxiliary system in a first mode; controlling the first sub-fab auxiliary system with a sub-fab auxiliary system controller, wherein the sub-fab auxiliary system controller receives instructions from a sub-fab front end controller; sending a first signal from the process tool controller to the sub-fab front end controller; sending a first instruction from the sub-fab front end controller to the sub-fab auxiliary system controller; and in response to the first instruction, operating the first sub-fab auxiliary system in a second mode.

Other features and aspects of the present invention will become more fully apparent from the following detailed description, the appended claims and the accompanying drawings.

### BRIEF DESCRIPTION OF THE DRAWINGS

FIG. 1 is a schematic depiction of a system of the invention for operating an electronic device manufacturing system sub-fab.

FIG. 2 is a schematic drawing of an alternative system of the invention for operating an electronic device manufacturing system sub-fab.

FIG. 3 is a schematic drawing of another alternative system of the invention for operating an electronic device manufacturing system sub-fab.

FIG. 4 is a schematic drawing of another alternative system of the invention for operating an electronic device manufacturing system sub-fab.

FIG. 5 is a schematic drawing of yet another alternative system of the invention for operating an electronic device manufacturing system sub-fab.

FIG. 6 is a flowchart which depicts a method of the present invention for operating an electronic device manufacturing system.

FIG. 7 is a flowchart which depicts a second method of the present invention for operating an electronic device manufacturing system.

FIG. 8 is a flowchart which depicts a third method of the present invention for operating an electronic device manufacturing system.

FIG. 9 is a flowchart which depicts a fourth method of the present invention for operating an electronic device manufacturing system.

FIG. 10 is schematic depiction of a system of the invention for routing cooling water.

### DETAILED DESCRIPTION

As described above, sub-fabs, as they are typically operated prior to the present invention, may be expensive to operate, consume large amounts of energy and other resources, wear relatively quickly and produce large amounts of waste heat. One reason for this may be that sub-fab equipment has been designed to operate and has been operated continuously in high capacity modes (“high energy mode”) to reduce the likelihood that the sub-fab will encounter a worst-case effluent load from the clean room which it is not able to fully abate. Such sub-fab equipment design may be effective, but inefficient, because some or most of the time the sub-fab actually encounters an effluent load which is significantly less than a worst-case effluent load. In addition to abatement resources, other resources from the sub-fab have been provided constantly in the same “worst-case,” high capacity mode, even when such a high capacity is not needed.

In an effort to increase the efficiency of the sub-fab, sub-fab equipment has recently been designed to operate in one or more lower capacity or energy modes in addition to a high capacity or energy mode. For ease of reference “mode,” “operational mode” and “energy mode” may be used interchangeably herein. Such lower energy modes may include an off mode, an idle mode (or “very low energy mode”), and one or more intermediate “reduced” or “low” energy modes which may be used to support a process tool which is operating under loads which are less than maximum or “worst case” loads. Sub-fab equipment which has been so designed may be referred to as “smart” sub-fab equipment. In addition to multiple operational modes, “smart” sub-fab equipment may also include backup systems and devices, energy recovery systems and devices, reagent recovery systems and devices, reagent supply systems and devices and the switches, valves, pumps, and other hardware and logic devices which may be required to utilize such systems and devices.

Unfortunately, although smart sub-fab equipment may be available, the smart sub-fab equipment must still operate in high energy mode unless the smart sub-fab equipment is “aware” that it is receiving less than a worst case effluent load. One way in which sub-fab equipment has been given the awareness of what effluent load it is encountering, or what other sub-fab resources may be required by the process tool and/or by the sub-fab itself, is to use instruments which can provide such information to the smart sub-fab equipment. In addition, the smart sub-fab equipment has been provided with a controller which may act on the knowledge/information provided by the instruments. Such instruments may include pressure, flow, chemical composition, temperature, and any other instruments which may provide useful information to a sub-fab system controller. Such instruments may be included in feed-forward and/or feedback circuits. The smart sub-fab equipment controllers may include process logic controllers or any other suitable logic devices.

Such use of instrumentation and controllers may be effective, but still may have drawbacks. For example, the instrumentation may be expensive, prone to wear and/or damage, require periodic calibration, and/or may introduce delay which may cause the smart sub-fab equipment to react to a change in effluent makeup or volume or other process tool or sub-fab resource requirement too slowly. A slow response by the sub-fab system may result in a failure to fully abate an effluent which it is being asked to abate, or in a failure to adequately cool the process tool or a sub-fab system. In addition, having controllers for each of the smart sub-fab system/devices may lead to added expense and additional opportunity for failure. Also, the use of instrumentation and smart sub-fab equipment controllers may not enable the smart sub-fab equipment to anticipate changes in effluent makeup and/or load so that the sub-fab equipment may ramp up from a lower operational mode to a higher operational mode in advance of encountering a need for such a higher operational mode.

The present invention provides apparatus and methods for addressing the aforementioned problems. We have discovered that the smart sub-fab equipment may be operated efficiently without the use of instrumentation to inform the sub-fab equipment of the state of the process tool or what resources may be required by the process tool and/or the sub-fab itself. In some aspects, the present invention uses the process tool controller to inform the sub-fab equipment controller(s) of the state of the process tool, the volume and chemical makeup of the effluent produced by the process tool, and the resource requirements of the process tool and the sub-fab. In fact, in some aspects of the present invention, the sub-fab equipment may be operated even more efficiently by the application of knowledge of future process tool operating states which can be obtained from the process tool controller.

In some aspects, the present invention may provide a mainframe system equipped with a number of shared control, distribution and packaging systems with connection points for chiller and vacuum pump sub-fab devices. The mainframe may provide shared control and packaging for the sub-fab devices. The mainframe may provide a platform for the safe incorporation of sub-fab devices without their individual control, distribution and packaging systems.

In some aspects, the present invention may integrate and/or consolidate multiple sub-fab devices under one or more sub-fab controllers which may be process logic controllers, computers, and/or any other suitable electronic logic devices. One or more particular sub-fab systems and/or devices may be directly controlled by a PLC, which may be a relatively simple and fast controller. Alternatively, one or more of the sub-fab systems and/or devices may be directly controlled by a higher-level controller such as a sub-fab front end controller. The sub-fab front end controller may be a higher-level logic device than a PLC and capable not only of directly controlling operation of hardware which may cause the sub-fab system/device to operate in a desired mode, but also to be programmed to make decisions regarding a mode which a sub-fab system should operate in. The sub-fab front end controller may communicate with and/or control each of the sub-fab devices, and the sub-fab front end controller may be linked to and communicate with one or more process tool controllers. The process tool controller, as the name suggests, may be adapted to control the operation of one or more process tools. The process controller may include or be connected with a database from which it may calculate or otherwise become aware of multiple factors which may be based on the state of the process tool and which may be used to select appropriate operating modes for the sub-fab equipment. These factors may include the nature and volume of effluent which is produced by the process tool at any particular time, and/or the amount of resources which may be required by the process tool and/or the sub-fab which supports the process tool at any particular time. Thus, the present invention may provide for the receipt by the sub-fab front end controller of information with which the sub-fab front end controller may make decisions regarding control of the sub-fab equipment.

For example, a process tool may include up to six or more process chambers, each of which may be capable of performing one or more processes and each of which may require periodic cleaning. The number of process chambers may be more or less, and is not critical to the invention. At any particular time, therefore, the requirements of the process tool for resources such as reagents, cooling, and abatement, etc., may fall within a range of zero, if the process tool is idle, up to a maximum requirement for each of the resources under a worst case scenario.

The process tool controller may know what the resource requirements of the process tool are, because the process tool controller knows what each chamber is doing at any particular time. The process tool controller may also contain or be given access to a database from which the process tool controller may calculate what the resource requirements of each chamber are at any particular time.

The process tool controller may also be programmed to know or may have access to a database which tells the process tool controller how long processes, transportation, and cleaning, etc. take and knows when the next process in each chamber will start. The process tool controller can therefore give advance warning to the sub-fab front end controller that additional abatement and or other resources will be required at a particular time. This advanced warning may enable the front end controller to ramp up a sub-fab system and/or device which is currently operating in a less than maximum load so that the system and/or device will be ready to provide sufficient resources when the resources are needed.

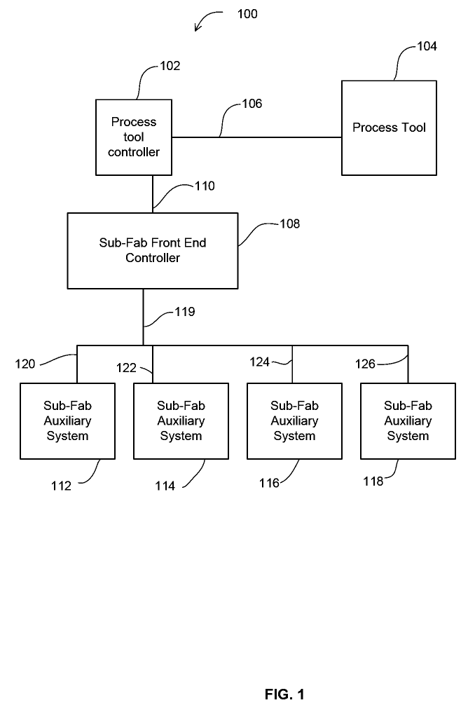

FIG. 1 is a schematic depiction of a system 100 of the invention for operating a sub-fab. System 100 may include a process tool controller 102 which may be linked to a process tool 104 through communication link 106. Process tool controller 102 may be any microcomputer, microprocessor, logic circuit, a combination of hardware and software, or the like, suitable to control the operation of the process tool 104. For example, process tool controller 102 may be a PC, server tower, single board computer, and/or a compact PCI, etc. Process tool 104 may be any electronic device manufacturing process tool which requires effluent abatement and/or other resources from a sub-fab support system. Communication link 104 (and any other communication link described herein) may be hardwired or wireless and may use any suitable communication protocol such as, SECS/GEM, HSMS, OPC, and/or Device-Net.

The process tool controller 102 may be linked to the sub-fab front end controller 108 by means of communication link 110. The sub-fab front end controller 108 may be any microcomputer, microprocessor, logic circuit, a combination of hardware and software, or the like, suitable to control the sub-fab auxiliary systems/device 104. For example, sub-fab front end controller 108 may be a PC, server tower, single board computer, and/or a compact PCI, etc.

The sub-fab front end controller 108 may in turn be linked to sub-fab auxiliary systems/devices 112, 114, 116 and 118 through communication links 120, 122, 124 and 126, respectively. The Sub-fab auxiliary systems/devices may each have a controller (not shown), such as a PLC. Alternatively, the sub-fab front end controller 108 may perform the functionality of a lower-level PLC controller for any or all of the sub-fab auxiliary systems/devices. Although four sub-fab auxiliary systems/devices are shown, it should be noted that more or fewer than four sub-fab auxiliary systems/devices may be linked to the sub-fab front end controller 108. Sub-fab auxiliary systems/devices may include abatement tools, ac power distributors, primary vacuum pumps, spare vacuum pumps, water pumps, chillers, heat exchangers, process cooling water supplies and delivery systems, electrical power supplies and delivery systems, inert gas dumps, valves, device controllers, clean dry air supplies and delivery systems, ambient air supplies and delivery systems, inert gas supplies and delivery systems, fuel supplies and delivery systems, touch screens, process logic controllers, reagent supplies and delivery systems, etc.

In operation, process tool controller 102 may control process tool 104 by operating one or more of robots, doors, pumps, valves, plasma generators, power supplies, etc. As described above, process tool controller 102 may be constantly aware regarding the state of, and resource requirements of, each chamber in the process tool 104 and of the process tool 104 as a whole. Process tool controller 102 may have access to a database (not shown) which the process tool controller 102 may use to calculate the resource requirements of the chambers (not shown) and the process tool 104 as a whole. In addition, the process tool controller 102 may be linked to instruments in the sub-fab (not shown) from which the process tool controller 102 may calculate the resource requirements of sub-fab systems and/or devices. Alternatively the sub-fab front end controller 108 may be linked to the instruments in the sub-fab (not shown), calculate the resource requirements of the sub-fab systems and/or devices and provide information regarding the resource requirements of the sub-fab systems and/or devices to the process tool controller 102.

The process tool controller 102 may communicate such resource requirements to the sub-fab front end controller 108 which may in turn control one or more sub-fab auxiliary systems/devices 112, 114, 116 and 118 by operating pumps, switches valves, power supplies, and/or other hardware through communication links 119, 120, 122, 124 and 126. In this fashion, the amount of energy which may be required to operate the sub-fab equipment may be reduced to a level which provides sufficient resources to safely and efficiently operate the process tool 104 and to fully abate the effluent which flows from the process tool 104. By sufficient resources is meant a minimum amount of resources to avoid negatively impacting the process tool 104 and/or the throughput and/or efficiency of the process tool 104, plus any additional amount of resources above the minimum required resources to provide a desired margin of safety and/or error.

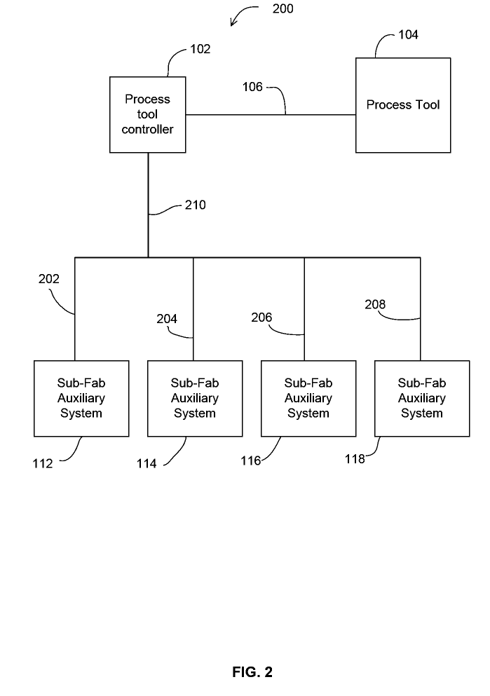

FIG. 2 is a schematic drawing of an alternative system 200 of the invention for operating a sub-fab. The system 200 and its component parts may be similar to the system 100 with the exception that the system 200 does not include a sub-fab front end controller. Instead, the process tool controller 102 may be directly linked to the sub-fab auxiliary systems/devices 112, 114, 116, and 118, through communication links 202, 204, 206, 208, and 210. Just as in system 100, although four sub-fab auxiliary systems/devices are shown, it should be noted that more or fewer than four sub-fab auxiliary systems/devices may be linked to the process tool controller 102. In system 200, the process tool controller 102 may perform all of the functionality of process tool controller 102 of system 100, and in addition, all of the functionality of the sub-fab front end controller 108 of system 100.

System 200 may operate similarly to system 100, as described above, with the exception that the functionality provided in system 100 by the sub-fab front end controller 108 may be provided in system 200 by the process tool controller 102.

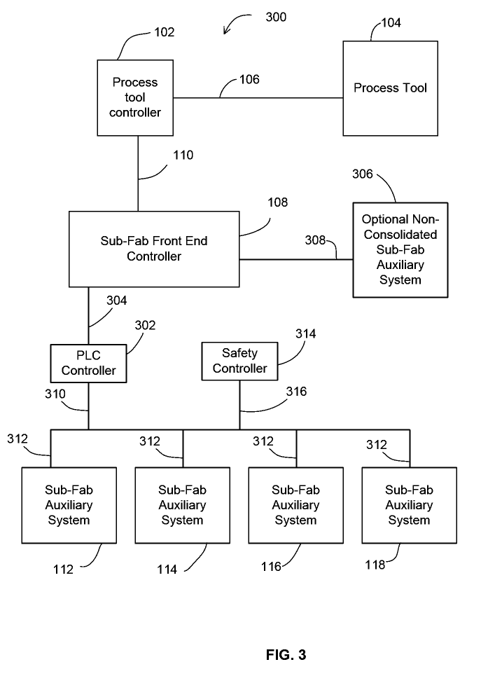

FIG. 3 is a schematic drawing of another alternative system 300 of the invention for operating a sub-fab. The system 300 and its component parts may be similar to the system 100, with the following differences. Instead of the sub-fab front end controller 108 being linked to each of the sub-fab auxiliary systems/devices 112, 114, 116, and 118, the sub-fab front end controller 108 may be connected to a PLC controller 302 through communication link 304. The PLC controller 302 may in turn be linked to the sub-fab auxiliary systems 112, 114, 116, and 118, through communication links 310 and 312. System 300 may also include safety controller 314 which may be connected to the sub-fab auxiliary systems 112, 114, 116, and 118, through communication links 316 and 312. In addition, system 300 may include optional nonconsolidated sub-fab auxiliary systems 306. By nonconsolidated sub-fab auxiliary system is meant a sub-fab auxiliary system which is not consolidated under PLC controller 302. Such nonconsolidated sub-fab auxiliary systems 306 may incorporate controllers or may be controlled directly by the sub-fab front end controller 108.

In operation, system 300 may operate similarly to system 100, with the following differences. In system 300 the sub-fab front end controller 108 does not directly control the sub-fab auxiliary systems 112, 114, 116 and 118. Instead, the sub-fab front end controller 108 sends commands to the PLC controller 302, which in turn controls the operation of sub-fab auxiliary systems 112, 114, 116, and 118. In addition, the sub-fab front end controller 108 of FIG. 3 may control the operation of the nonconsolidated sub-fab auxiliary systems 306 by sending commands to the controller (not shown) of the nonconsolidated sub-fab auxiliary system 306. It should be noted that the nonconsolidated sub-fab auxiliary system 306 of FIG. 3 may be incorporated into any sub-fab control system which utilizes a sub-fab front end controller 108.

Safety controller 314 may be a process logic controller or any other suitable electronic logic device which may monitor the sub-fab auxiliary systems 112, 114, 116 and 118 for safety faults. Safety controller 314 may shut down any or all of the sub-fab auxiliary systems 112, 114, 116, and 118 without asking for or receiving permission from any other controller.

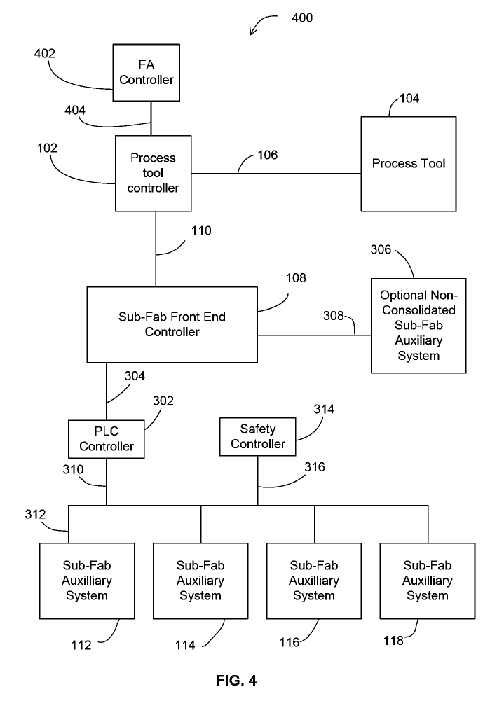

FIG. 4 is a schematic drawing of another alternative system 400 of the invention for operating a sub-fab. The system 400 may be similar to the system 300 with the following differences. The process tool controller 102 may additionally be connected to a factory automation controller, or FA controller, 402. The FA controller 402, like the process tool controller 102 and the sub-fab front end controller 108, May be any microcomputer, microprocessor, logic circuit, a combination of hardware and software, or the like, suitable to provide factory automation to the fab. For example, FA controller 402 may be a PC, server tower, single board computer, and/or a compact PCI, etc.

In operation, by linking the process tool controller 102 with the FA controller 402, it may be possible for the process tool controller 102 to know the resource requirements for the process tool further into the future than would be possible if the process tool controller were not connected to the FA controller. Being able to know the resource requirements for the process tool further into the future may allow the sub-fab auxiliary systems/devices to be operated even more efficiently. For example, if due to production requirements the FA controller decides to reduce production of wafers, it may be possible to completely shut down a process tool 104. In such a case it may be possible to shut down the sub-fab auxiliary systems/devices which support the shutdown process tool, or simply to place them in an idle mode. Then, when the FA controller decides to increase the production of wafers and to startup the process tool 104, the FA controller 402 may provide such information to the process tool controller 102 sufficiently in advance of the desired startup time to enable the process tool controller 102 to cause the sub-fab front end controller 108 to ramp up the sub-fab auxiliary systems/devices in sufficient time to be ready for the process tool 104 requirements when the process tool does start up.

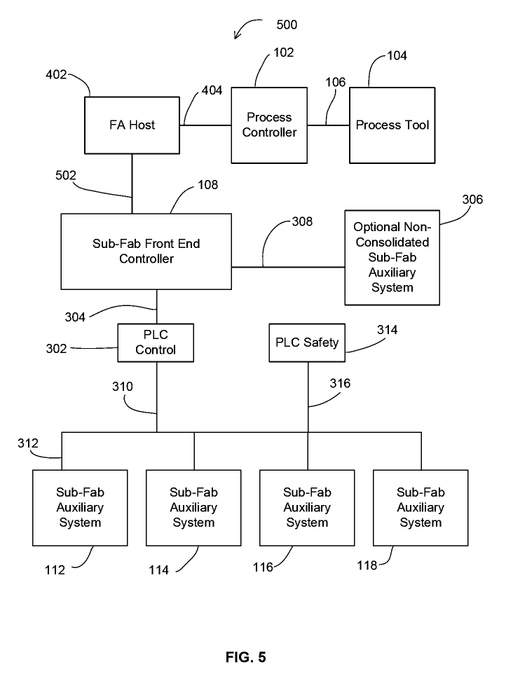

FIG. 5 is a schematic drawing of yet another alternative system 500 of the invention for operating a sub-fab. The system 500 may be similar to the system 400 with the following differences. In system 500, the process controller 102 is not linked with the sub-fab front end controller 108. Instead, the FA host 402 may be linked to the sub-fab front end controller 108 through communication link 502.

In operation, system 500 may operate similarly to system 400 with the following differences. In system 500, because the process controller 102 is not linked with the sub-fab front end controller 108, the FA host 402 may assume the responsibilities of the process controller 102 with respect to the sub-fab front end controller 108. Thus, in system 500 the FA host controller 402 may provide the functionality of process controller 102 with respect to sub-fab front end controller 108, as such functionality is described with respect to system 400 in FIG. 4.

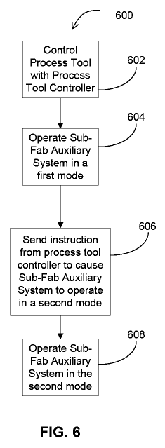

FIG. 6 is a flowchart which depicts a method 600 of the present invention for operating an electronic device manufacturing system. Method 600 begins in step 602 in which a process tool controller controls a process tool. In step 604, a sub-fab auxiliary system/device is operated in a first mode. In step 606, an instruction is sent from the process tool controller to cause the sub-fab auxiliary system/device to change to a second operating mode. In step 608, the sub-fab auxiliary system/device is operated in the second mode. An operating mode may be one of at least the following modes: an off mode, in which the sub-fab auxiliary system/device is not operating; an idle mode, in which the sub-fab auxiliary system/device is operating at a very low, sustainable level of operation from which it can recover to a higher mode without having to undergo startup procedures; a maximum or worst-case mode, in which the sub-fab auxiliary system/device is operating at its maximum capacity; and in one or more modes between idle mode and maximum mode in which the sub-fab auxiliary system/device is operating at an intermediate capacity. Other types of modes are possible. For example, a two way valve may be opened or closed; a three way valve may direct a fluid in one direction or another direction; a switch may be opened or closed; an effluent stream may be diverted from one inlet to another or from one abatement unit to another; and an inert gas dump may be placed into a recovery mode, a hold mode, or a dump mode. This list is not meant to be limiting and the present invention may be useful with any sub-fab auxiliary system/device which is capable of being operated in different modes and also may be useful with any sub-fab auxiliary system/device yet to be invented which is capable of being operated in different modes.

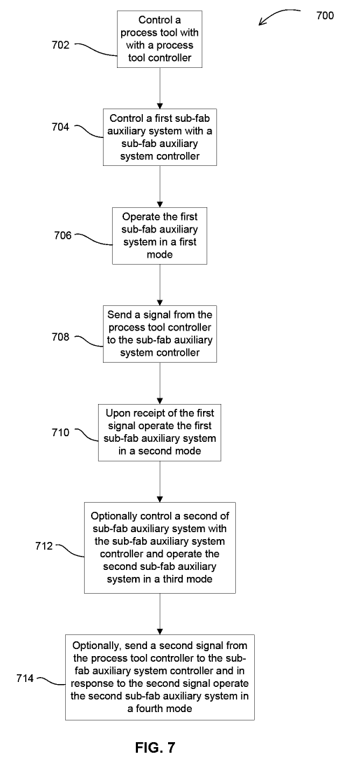

FIG. 7 is a flowchart which depicts a method 700 of the present invention for operating an electronic device manufacturing system. Method 700 begins in step 702 where a process tool controller is used to control a process tool. In step 704, a sub-fab auxiliary system is controlled using a sub-fab auxiliary system controller. In step 706, the first sub-fab auxiliary system is operated in a first mode. In step 708, the process tool controller sends a signal to the sub-fab auxiliary system controller to change the sub-fab auxiliary system's operating mode to a second mode. In step 710, upon receipt of the first signal to operate the first sub-fab auxiliary system in the second mode, the sub-fab auxiliary system controller issues appropriate commands to cause the sub-fab auxiliary system to operate in the second mode. Method 700 may also be extended through optional steps 712 and 714 to provide a method in which two sub-fab auxiliary systems may be controlled pursuant to the present invention. Thus, in step 712, the sub-fab auxiliary system controller may be used to control a second sub-fab auxiliary system in a third mode. In step 714, the process tool controller may send a second signal to the sub-fab auxiliary system controller to operate the second sub-fab auxiliary system in a fourth mode. In response, the sub-fab auxiliary system controller may issue commands which cause the second sub-fab auxiliary system to be operated in the fourth mode.

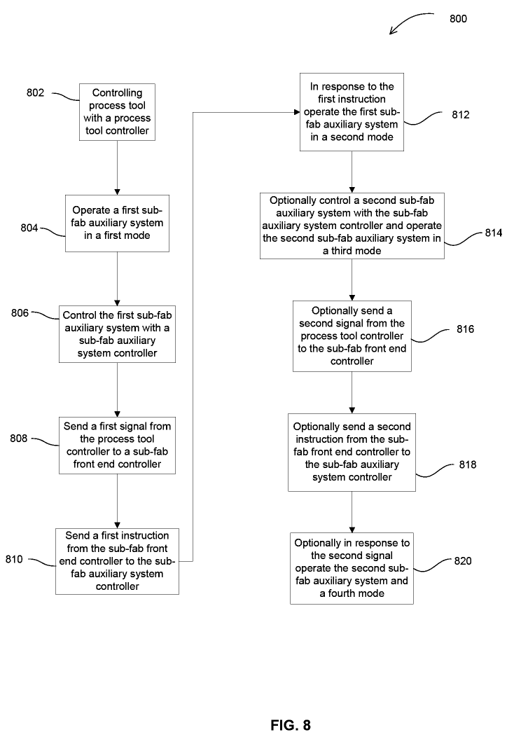

FIG. 8 is a flowchart which depicts a method 800 of the present invention for operating an electronic device manufacturing system. Method 800 may be similar to method 700 but includes additional steps to allow for the incorporation into the method of a sub-fab front end controller. Thus, method 800 begins in step 802 in which a process tool controller is used to control a process tool. In step 804, a first sub-fab auxiliary system is operated in a first mode. In step 806, a sub-fab auxiliary system controller is used to control the first sub-fab auxiliary system. In step 808, the process tool controller sends a first signal to the sub-fab front end controller to indicate that the first sub-fab auxiliary system should be operated in a second mode. In step 810, the sub-fab front end controller sends a first instruction to the sub-fab auxiliary system controller to operate the sub-fab auxiliary system in the second mode. In step 812, in response to the first instruction, the sub-fab auxiliary system controller operates the sub-fab auxiliary system in the second mode. Method 800 may also be extended through optional steps 816, 818, and 820, to provide a method in which two sub-fab auxiliary systems may be controlled pursuant to the present invention. Thus in step 814, the sub-fab auxiliary system controller is used to control a second sub-fab auxiliary system and to operate the second sub-fab auxiliary system in a third mode. In step 816, the process tool controller sends a second signal to the sub-fab front end controller to the effect that the second sub-fab auxiliary system should be operated in a fourth mode. In step 818, the sub-fab front end controller sends a second instruction to the sub-fab auxiliary system controller. In step 820, in response to the second signal from the sub-fab front end controller, the sub-fab auxiliary system controller causes the second sub-fab auxiliary system to operate in the fourth mode.

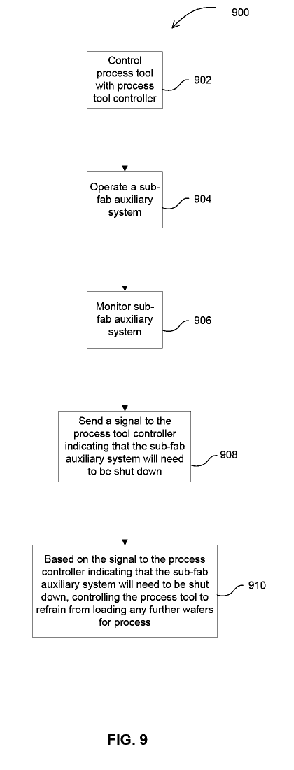

FIG. 9 is a flowchart which depicts a method 900 of the present invention for operating an electronic device manufacturing system. Method 900 begins in step 902, in which a process tool is controlled with a process tool controller. In step 904, a sub-fab auxiliary system is operated in support of the process tool. In step 906, the sub-fab auxiliary system is monitored. The sub-fab auxiliary system may be monitored by a PLC, by any sub-fab front end controller, or directly by the process tool controller, as described above. In step 908, a signal is sent to the process tool controller which indicates that the sub-fab auxiliary system which is being monitored will need to be shut down. In step 910, the process tool controller, in response to receiving the signal, controls the process tool so that no additional wafers are loaded into the process tool for processing. This method may prevent a wafer which would otherwise be in a process chamber when the system needs to be shut down from being wasted.

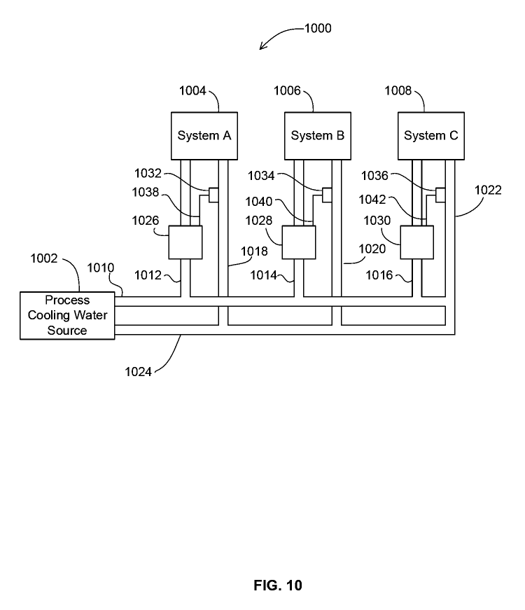

FIG. 10 is schematic depiction of a system 1000 of the invention for routing cooling water. System 1000 may include process cooling water source 1002. Process cooling water source 1002 may be any suitable source of cooling water, such as, for example, a chiller or a cooling tower, etc. Process cooling water source 1002 may be connected to clean room and/or sub-fab systems/devices 1004, 1006, and 1008 by coolant supply conduits 1010, 1012, 1014, and 1016, and by coolant return conduits 1018, 1020, 1022, and 1024. It should be noted that whereas three clean room and/or sub fab systems/devices 1004, 1006, 1008 are depicted, any number of clean room and/or sub fab system/devices may be employed. Examples of clean room and/or sub-fab system/devices may include, but are not limited to, process chambers, abatement units, process vacuum pumps, and load locks, etc.

System 1000 may also include thermal valves 1026, 1028, and 1030, situated in coolant supply conduits 1012, 1014, and 1016, respectively. Thermal valves 1026, 1028, and 1030, may be linked to temperature sensors 1032, 1034, and 1036, respectively, via communication links 1038, 1040, and 1042, respectively. Thermal valves may be adapted to flow more or less coolant depending upon the temperature reported to the thermal valve from the temperature sensor.

In operation, target returning coolant temperatures in conduits 1018, 1020, and 1022, may be selected according to the cooling needs of systems 1004, 1006, and 1008, respectively. Using system 1004 as an example, if temperature sensor 1032 detects that the temperature of the returning coolant in conduit 1018 has exceeded a preselected upper set point, then thermal valve 1026, which has received this information through communication link 1038, may flow additional coolant into system 1004. Flowing additional coolant into system 1004 may have the effect of lowering the temperature of system 1004 and lowering the temperature of the returning coolant in conduit 1018. On the other hand, if the temperature of the returning coolant in conduit 1018 falls below a lower temperature set point, thermal valve 1026 which has received this information from temperature sensor 1032 may flow less coolant to system 1004. Flowing less coolant to system 1004 may have the effect of increasing the temperature of system 1004 and of the returning coolant in conduit 1018. In this way, system 1000 may control the temperatures of systems 1004, 1006, at 1008.

The foregoing description discloses only exemplary embodiments of the invention. Modifications of the above disclosed apparatus and methods which fall within the scope of the invention will be readily apparent to those of ordinary skill in the art. For example, although the examples describe only two operating modes per sub-fab auxiliary system, it should be understood that each sub-fab auxiliary system may operate in multiple modes. In some embodiments, the apparatus and methods of the present invention may be applied to semiconductor device processing and/or electronic device manufacturing.

Accordingly, while the present invention has been disclosed in connection with exemplary embodiments thereof, it should be understood that other embodiments may fall within the spirit and scope of the invention, as defined by the following claims.

The invention claimed is:

1. An electronic device manufacturing system comprising:
a process tool;
a process tool controller linked to the process tool, wherein the process tool controller is adapted to control the process tool;
a first sub-fab auxiliary system linked to the process tool controller;
wherein the first sub-fab auxiliary system is adapted to operate in a first operating mode and a second operating mode; and
wherein the process tool controller is adapted to cause the first sub-fab auxiliary system to change from the first operating mode to the second operating mode.

2. The electronic device manufacturing system of claim 1 wherein the first and second operating modes comprise energy modes.

3. The electronic device manufacturing system of claim 1 wherein the link between the process tool controller and the first sub-fab auxiliary system further comprises a sub-fab auxiliary system controller, wherein the sub-fab auxiliary system controller is adapted to receive a signal from the process tool controller and to cause the first sub-fab auxiliary system to change operating mode from the first operating mode to the second operating mode.

4. The electronic device manufacturing system of claim 3 further comprising a second sub-fab auxiliary system linked to the sub-fab auxiliary system controller;
wherein the second sub-fab auxiliary system is adapted to operate in a third operating mode and a fourth operating mode; and
wherein the sub-fab auxiliary system controller is further adapted to cause the second sub-fab auxiliary system to change operating mode from the third operating mode to the fourth operating mode.

5. An electronic device manufacturing system comprising:
a process tool;
a process tool controller linked to the process tool, wherein the process tool controller is adapted to control the process tool;
a sub-fab front end controller linked to the process tool controller; and
a first sub-fab auxiliary system linked to the sub-fab front end controller, wherein the first sub-fab auxiliary system is adapted to operate in a first operating mode and a second operating mode;
wherein the sub-fab front end controller is adapted to receive a first signal from the process tool controller; and
wherein the sub-fab front end controller is adapted to cause the first sub-fab auxiliary system to change from the first operating mode to the second operating mode in response to receipt of the first signal.

6. The electronic device manufacturing system of claim 5 wherein the first and second operating modes comprise energy modes.

7. The electronic device manufacturing system of claim 5 further comprising a second sub-fab auxiliary system linked to the sub-fab front end controller, wherein the second sub-fab auxiliary system is adapted to operate in a third operating mode and a fourth operating mode;
wherein the sub-fab front end controller is adapted to receive a second signal from the process tool controller; and
wherein the sub-fab front end controller is adapted to cause the second sub-fab auxiliary system to change from the third operating mode to the fourth operating mode in response to receipt of the second signal.

8. The electronic device manufacturing system of claim 5:
wherein the link between the sub-fab front end controller and the first sub-fab auxiliary system further comprises a sub-fab auxiliary system controller, and
wherein the sub-fab auxiliary system controller is adapted to receive an instruction from the sub-fab front end controller and to cause the first sub-fab auxiliary system to change operating mode from the first operating mode to the second operating mode in response to receipt of the instruction from the sub-fab front controller.

9. The electronic device manufacturing system of claim 8 further comprising a second sub-fab auxiliary system linked to the sub-fab auxiliary system controller;
wherein the second sub-fab auxiliary system is adapted to operate in a third operating mode and a fourth operating mode; and
wherein the sub-fab auxiliary system controller is further adapted to receive a second instruction from the sub-fab front end controller and to cause the second sub-fab auxiliary system to change operating mode from the third operating mode to the fourth operating mode in response to receipt of the second instruction.

10. A method for operating an electronic device manufacturing system comprising:
controlling a process tool with a process tool controller;
operating a sub-fab auxiliary system in a first mode; and
operating the sub-fab auxiliary system in a second mode in response to receipt by the sub-fab auxiliary system of a command from the process tool controller.

11. The method of claim 10 wherein the first and second modes comprise energy modes.

12. A method for operating an electronic device manufacturing system comprising:
controlling a process tool with a process tool controller;
controlling a first sub-fab auxiliary system with a sub-fab auxiliary system controller;
operating the first sub-fab auxiliary system in a first mode;
sending a first signal from the process tool controller to the sub-fab auxiliary system controller; and
in response to the first signal, operating the first sub-fab auxiliary system in a second mode.

13. The method of claim 12 wherein the first and second modes comprise energy modes.

14. The method of claim 12 further comprising:
controlling a second sub-fab auxiliary system with the sub-fab auxiliary system controller; and
operating the second sub-fab auxiliary system in a third mode.

15. The method of claim 14 further comprising:
sending a second signal from the process tool controller to the sub-fab auxiliary system controller; and
in response to the second signal, operating the second sub-fab auxiliary system in a fourth mode.

16. The method of claim 15 wherein the first and second signals are the same signal.

17. The method of claim 15 wherein the first and second signals are different signals.

18. A method for operating an electronic device manufacturing system comprising:
controlling a process tool with a process tool controller;
operating a first sub-fab auxiliary system in a first mode;
controlling the first sub-fab auxiliary system with a sub-fab auxiliary system controller, wherein the sub-fab auxiliary system controller receives instructions from a sub-fab front end controller;
sending a first signal from the process tool controller to the sub-fab front end controller;
sending a first instruction from the sub-fab front end controller to the sub-fab auxiliary system controller; and
in response to the first instruction, operating the first sub-fab auxiliary system in a second mode.

19. The method of claim 18 wherein the first and second modes comprise energy modes.

20. The method of claim 19 further comprising:
controlling a second sub-fab auxiliary system with the sub-fab auxiliary system controller; and
operating the second sub-fab auxiliary system in a third mode.

21. The method of claim 20 further comprising:
sending a second signal from the process tool controller to the sub-fab front end controller;
sending a second instruction from the sub-fab front end controller to the sub-fab auxiliary system controller; and
in response to the second signal, operating the second sub-fab auxiliary system in a fourth mode.

22. The method of claim 21 wherein the first and second signals are the same signal.

23. The method of claim 21 wherein the first and second signals are different signals.
